(19) United States
(12) Patent Application Publication
(10) Pub. No.: US 2019/0082070 A1
(43) Pub. Date: Mar. 14, 2019

(54) IMAGE PROCESSING APPARATUS AND SLEEP CANCELLATION METHOD

(71) Applicants: KABUSHIKI KAISHA TOSHIBA, Tokyo (JP); TOSHIBA TEC KABUSHIKI KAISHA, Tokyo (JP)

(72) Inventor: Kazuo Sumioka, Yokohama Kanagawa (JP)

(21) Appl. No.: 15/698,678

(22) Filed: Sep. 8, 2017

(51) Int. Cl. H04N 1/00; G06K 9/00

(52) U.S. Cl. CPC H04N 1/00896; H04N 1/00891; H04N 1/00037; H04N 2201/0094; H04N 1/00251; H04N 1/00336; G06K 9/00342; H04N 1/00411

(57) ABSTRACT

In accordance with an embodiment, an image processing apparatus comprises an image capturing device and a sleep controller. The image capturing device photographs the periphery thereof. The sleep controller cancels a sleep state if it is predicted that the image processing apparatus is used based on a feature data in a plurality of captured images continuously captured by the image capturing device.

### FIELD

Embodiments described herein relate generally to an image processing apparatus and a sleep cancellation method.

### BACKGROUND

Conventionally, an image forming apparatus returns from a sleep state if it determines that a human approaches the apparatus by using a human sensor. However, conventionally, there is a case in which the image forming apparatus returns from the sleep state to a ready state even if it is not used, and therefore the power consumption is undesirably increased.

### BRIEF DESCRIPTION OF THE DRAWINGS

FIG. 1 is an external view exemplifying the whole constitution of an image processing apparatus according to an embodiment;

FIG. 2 is a block diagram illustrating the functional components of the image processing apparatus;

FIG. 3 is a schematic block diagram illustrating the functional components of a controller;

FIG. 4 is a flowchart illustrating the flow of a generation processing of a movement pattern data in the image processing apparatus;

FIG. 5 is a flowchart illustrating the flow of a prediction processing in the image processing apparatus;

FIG. 6 is a flowchart illustrating the flow of a generation processing of an movement pattern data in a modification in the image processing apparatus; and

FIG. 7 is a flowchart illustrating the flow of a prediction processing in a modification in the image processing apparatus.

### DETAILED DESCRIPTION

In accordance with an embodiment, an image processing apparatus comprises an image capturing device and a sleep controller. The image capturing device captures the periphery thereof. The sleep controller cancels a sleep state if it is predicted that the image processing apparatus is used based on a feature data in a plurality of captured images continuously captured by the image capturing device.

In accordance with another embodiment, a sleep cancellation method involving capturing a periphery of an image processing apparatus; and canceling a sleep state if a prediction is generated that the image processing apparatus is used based on a feature data in a plurality of captured images continuously captured by the capturing.

In accordance with another embodiment, a sleep state processing method involves capturing a periphery of an image processing apparatus; canceling a sleep state if a prediction is generated that the image processing apparatus is used based on a feature data in a plurality of captured images continuously captured by the capturing; and storing the feature data to establish a threshold feature data for comparison to a current feature data to facilitate a future prediction.

Hereinafter, an image processing apparatus and a sleep cancellation method of an embodiment is described with reference to the accompanying drawings.

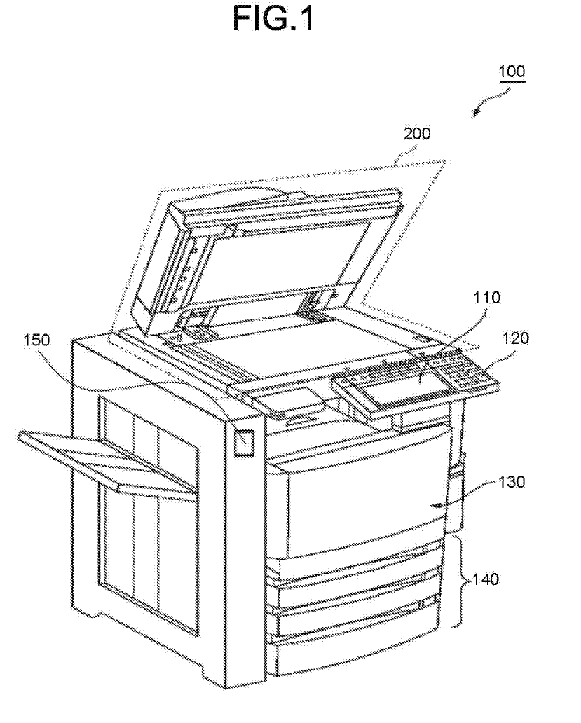

FIG. 1 is an external view exemplifying the whole constitution of an image processing apparatus 100 according to an embodiment.

The image processing apparatus 100 of an embodiment is an MFP (Multi-Function Peripheral) capable of forming a toner image on a sheet. The sheet is a document, a paper on which characters and images are recorded, or the like. The sheet may be an optional object as long as it can be read by the image processing apparatus 100. The image processing apparatus 100 reads an image shown on the sheet and generates digital data to generate an image file.

The image processing apparatus 100 includes a display 110, a control panel 120, a printer section 130, a sheet housing section 140, an image capturing section 150, and an image reading section 200. Further, the printer section 130 of the image processing apparatus 100 is a device for fixing a toner image. In the present embodiment, a case in which the printer section 130 is a device for fixing the toner image is described as an example.

The display 110 is an image display device such as a liquid crystal display, an organic EL (Electro Luminescence) display and the like. The display 110 displays various information relating to the image processing apparatus 100. The display 110 outputs a signal in response to an operation executed by a user to a controller of the image processing apparatus 100. The display 110 receives an operation by a user.

The control panel 120 includes a plurality of buttons. The control panel 120 receives an operation by a user. The control panel 120 outputs a signal corresponding to the operation executed by the user to the controller of the image processing apparatus 100. Furthermore, the display 110 and the control panel 120 may be integrally configured as a touch panel.

The printer section 130 executes an image forming processing. The printer section 130 forms an image on the sheet based on image information generated by the image reading section 200 or image information received via a communication path.

The sheet housing section 140 houses the sheet used for the image formation in the printer section 130.

The image capturing device 150 captures the periphery of the device. The image capturing device 150 is, for example, a camera. The image capturing device 150 is fixed at a certain position. The certain position is, for example, a front direction of the image processing apparatus 100.

The image reading section 200 reads the image serving as a reading object as the intensity of light. For example, the image reading section 200 reads an image printed on a sheet which is the reading object set in the image reading section 200. The image reading section 200 records the read image data. The recorded image data may be sent to another information processing apparatus via a network. The recorded image data may be used to form an image on the sheet by the printer section 130.

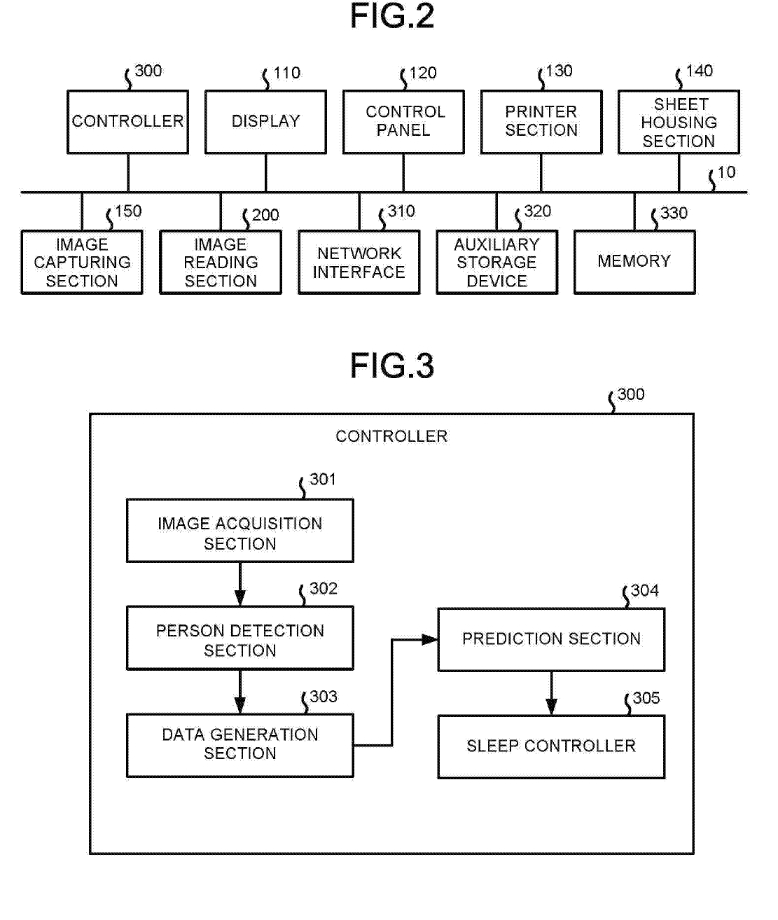

FIG. 2 is a block diagram illustrating the functional components of the image processing apparatus 100.

The display 110, the control panel 120, the printer section 130, the sheet housing section 140, the image capturing section 150 and the image reading section 200 are the same as those stated above, and thus, the description thereof is omitted. Hereinafter, a controller 300, a network interface 310, an auxiliary storage device 320 and a memory 330 are described. The functional sections are connected to each other via a system bus line 10 to be capable of executing data communication.

The controller 300 controls the operation of each functional section of the image processing apparatus 100. The controller 300 executes various processing by executing programs.

The network interface 310 transmits and receives data to and from other devices. The network interface 310 operates as an input interface to receive data transmitted from other devices. The network interface 310 operates as an output interface to transmit data to other devices.

The auxiliary storage device 320 is, for example, a hard disk or an SSD (solid state drive), and stores various data. Various data include, for example, a device use determination table, digital data, a job, and a job log. The device use determination table is used for determining whether to use the image processing apparatus 100. The auxiliary storage device 320 stores plural types of the device use determination tables.

For example, the auxiliary storage device 320 stores a first device use determination table and a second device use determination table. The first device use determination table is used to determine whether to use the image processing apparatus 100 for each specific person. In the first device use determination table, specific information for specifying a person, a movement pattern data of the person, and information indicating use or nonuse of the image processing apparatus 100 are associated with each other.

The information for specifying a person is, for example, an image of a face of the person. The movement pattern is, for example, an orientation of the face of the person, an orientation of a body, and a movement direction. The orientation of the face of the person is, for example, shown by an angle of the face of the person with respect to the image processing apparatus 100. For example, if the person faces the image processing apparatus 100 straight, the orientation of the face of the person is expressed by 0 degrees, and if the person faces the image processing apparatus 100 sideways, it is expressed as 90 degrees. The orientation of the body of the person is shown by the angle of the body of the person with respect to the image processing apparatus 100. For example, if the body of the person faces the image processing apparatus 100 straight, the orientation of the body of the person is expressed by 0 degrees, and if the body of the person faces the image processing apparatus 100 sideways, it is expressed as 90 degrees. The movement direction is shown by a movement angle with respect to the image processing apparatus 100 from relative coordinates by setting the position of the image processing apparatus 100 as a reference. The movement pattern data is composed of data of movement pattern for a predetermined time (for example, several seconds). In the present embodiment, the movement pattern data is a feature data obtained from a plurality of captured images.

The second device use determination table is used for determining whether or not a person other than the specific person uses the image processing apparatus 100. The person other than the specific person is a person not registered in the specific information of the first device use determination table. In the second device use determination table, the movement pattern data of a person and information on use or nonuse of the device are associated. The movement pattern data of a person in the second device use determination table is shown by the average of the movement pattern data of the person registered in the first device use determination table. The digital data is the digital data of image information generated by the image reading section 200.

The memory 330 is, for example, a RAM (Random Access Memory). The memory 330 temporarily stores data used by each functional section of the image processing apparatus 100. The memory 330 may store the digital data generated by the image reading section 200. The memory 330 may temporarily store the job and the job log.

FIG. 3 is a schematic block diagram illustrating the functional components of the controller 300. The controller 300 includes an image acquisition section 301, a person detection section 302, a data generation section 303, a prediction section 304 and a sleep controller 305.

The image acquisition section 301 acquires the image data captured by the image capturing device 150.

The person detection section 302 detects a person from the image data acquired by the image acquisition section 301.

The data generation section 303 collects the movement pattern at an arbitrary time after a person is detected, and generates the movement pattern data based on the collected movement pattern.

The prediction section 304 executes a processing if the image processing apparatus is in a sleep state. The prediction section 304 predicts whether or not the detected person uses the image processing apparatus 100 based on the generated movement pattern data and the device use determination table. For example, the prediction section 304 predicts whether or not the detected person uses the image processing apparatus 100 based on the generated movement pattern data and the first device use determination table. For example, the prediction section 304 predicts whether or not the detected person uses the image processing apparatus 100 based on the generated movement pattern data and the second device use determination table.

The sleep controller 305 controls the operation of the image processing apparatus according to the prediction result of the prediction section 304. For example, the sleep controller 305 cancels the sleep state of the device if the prediction section 304 predicts that the person uses the image processing apparatus 100. For example, the sleep controller 305 keeps the sleep state of the image processing apparatus if the prediction section 304 predicts that the person does not use the image processing apparatus 100.

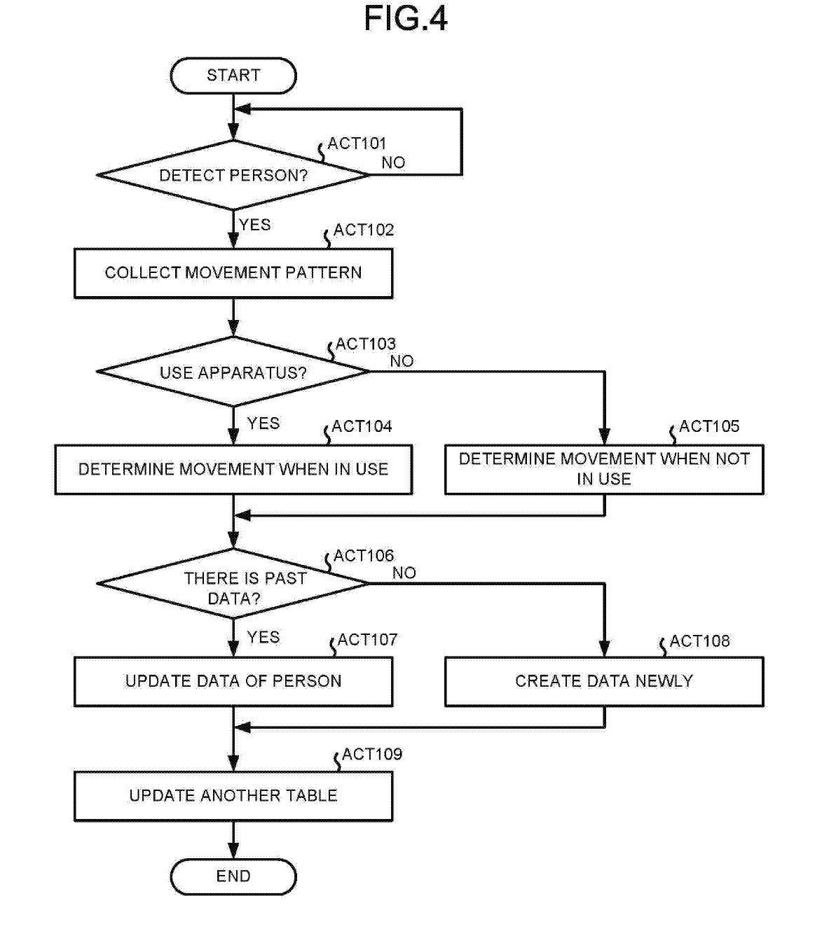

FIG. 4 is a flowchart illustrating the flow of a generation processing of the movement pattern data in the image processing apparatus 100. The processing in FIG. 4 is executed each time the image capturing device 150 acquires the image.

The image acquisition section 301 acquires the image data captured by the image capturing device 150. The image acquisition section 301 outputs the acquired image data to the person detection section 302. The person detection section 302 determines whether or not a person is detected from the output image data (ACT 101). If the person cannot be detected from the image data (No in ACT 101), the image processing apparatus 100 waits for until the person is detected from the image data.

On the other hand, if the person can be detected from the image data (Yes in ACT 101), the person detection section 302 outputs a message indicating that the person is detected together with the image data to the data generation section 303. If receiving the notification that the person is detected from the person detection section 302, the data generation section 303 detects the movement pattern from the output image data. For example, the data generation section 303 detects the orientation of the face of the person from the image data. The data generation section 303 collects the movement patterns by executing a processing of detecting the movement pattern for a predetermined time period at an arbitrary time (ACT 102). The data generation section 303 generates the movement pattern data by arranging the collected movement patterns in chronological order if the movement patterns for a predetermined time period are collected.

Thereafter, the data generation section 303 determines whether or not the image processing apparatus 100 is used (ACT 103). Whether the image processing apparatus 100 is used may be determined based on whether the control panel 120 is operated or whether the user actually logs in. If the control panel 120 is operated, the data generation section 303 determines that the image processing apparatus 100 is used. On the other hand, if the control panel 120 is not operated, the data generation section 303 determines that the image processing apparatus 100 is not used. If the user actually logs in, the data generation section 303 determines that the image processing apparatus 100 is used. On the other hand, if the user actually does not log in, the data generation section 303 determines that the image processing apparatus 100 is not used.

If the image processing apparatus 100 is used (Yes in ACT 103), the data generation section 303 determines the generated movement pattern data as the movement pattern data at the time the image processing apparatus 100 is used (ACT 104). On the other hand, if the image processing apparatus 100 is not used (No in ACT 103), the data generation section 303 determines the generated movement pattern data as the movement pattern data at the time the image processing apparatus 100 is not in use (ACT 105).

Thereafter, the data generation section 303 refers to the first device use determination table stored in the auxiliary storage device 320 to determine whether there is past data of the detected person (ACT 106). Whether there is the past data of the detected person is determined based on face collation between the image of the face of the person in the image data and the image of the face of the person in the specific information. If a collation rate between the image of the face of the person in the image data and the image of the face of the person in the specific information is equal to or larger than a threshold value, the data generation section 303 determines that there is the past data of the person. If the collation rate between the image of the face of the person in the image data and the image of the face of the person in the specific information is less than the threshold value, the data generation section 303 determines that there is no past data of the person.

If there is the past data of the detected person (Yes in ACT 106), the data generation section 303 updates the data of the detected person (ACT 107). The data generation section 303 updates the data in the first device use determination table. Specifically, the data generation section 303 first associates the specific information with the movement pattern data obtained in the current processing and information on use or nonuse. Next, the data generation section 303 adds the associated information to the first device use determination table. The data generation section 303 does not add the associated information for the same person if the same movement pattern data is already registered.

If there is no past data of the detected person (No in ACT 106), the data generation section 303 newly generates data of the detected person (ACT 108).

The data generation section 303 updates the data of the second device use determination table (ACT 109). Specifically, the data generation section 303 first calculates an average of all the movement pattern data registered in the first device use determination table. Next, the data generation section 303 determines use or nonuse from all the information on use or nonuse registered in the first device use determination table. For example, the data generation section 303 selects the use if a total number thereof is larger or the nonuse if a total number thereof is larger as the determination result from all the information on use or nonuse registered in the first device use determination table. Then, the data generation section 303 adds the calculated average movement pattern data and the information on use or nonuse in association with each other to the second device use determination table. Thus, the second device use determination table is updated.

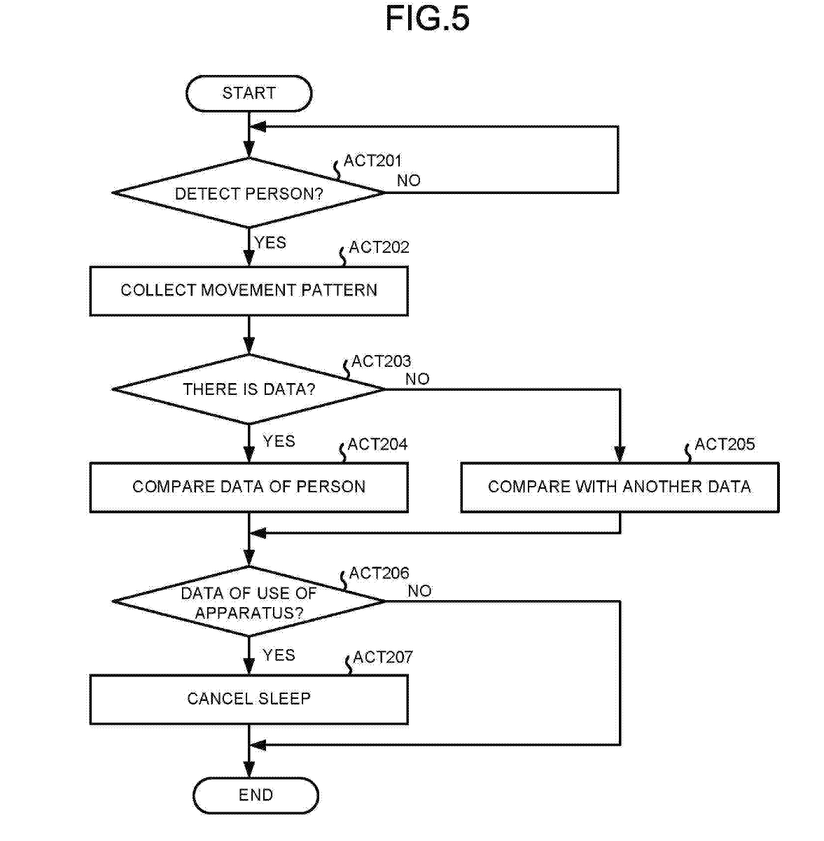

FIG. 5 is a flowchart illustrating the flow of a prediction processing in the image processing apparatus 100. The processing in FIG. 5 is executed at the time the image processing apparatus 100 is in the sleep state.

The image acquisition section 301 acquires the image data captured by the image capturing device 150. The image acquisition section 301 outputs the acquired image data to the person detection section 302. The person detection section 302 determines whether or not the person is detected from the output image data (ACT 201). If the person cannot be detected from the image data (No in ACT 201), the image processing apparatus 100 waits for until the person is detected from the image data.

On the other hand, if the person can be detected from the image data (Yes in ACT 201), the person detection section 302 outputs a message indicating that the person is detected together with the image data to the data generation section 303. If receiving the notification that the person is detected from the person detection section 302, the data generation section 303 detects the movement pattern from the output image data. The data generation section 303 collects movement patterns by performing a processing of detecting movement patterns for a predetermined time period at an arbitrary time (ACT 202). The data generation section 303 generates the movement pattern data by arranging the collected movement patterns in chronological order if the movement patterns for a predetermined time period are collected. The data generation section 303 outputs the generated movement pattern data to the prediction section 304.

The prediction section 304 refers to the first device use determination table to determine whether there is the movement pattern data of the detected person (ACT 203). Whether there is the movement pattern data of the detected person is determined by the face collation between the image of the face of the person in the image data and the image of the face of the person in the specific information. If the collation rate between the image of the face of the person in the image data and the image of the face of the person in the specific information is equal to or larger than the threshold value, the prediction section 304 determines that there is the movement pattern data of the person. If the collation rate between the image of the face of the person in the image data and the image of the face of the person in the specific information is less than the threshold value, the prediction section 304 determines that there is no movement pattern data of the person.

If there is the movement pattern data of the detected person (Yes in ACT 203), the prediction section 304 compares the movement pattern data of the detected person with the generated movement pattern data (ACT 204). Specifically, the prediction section 304 first selects a record corresponding to the detected person from the records registered in the first device use determination table. Next, the prediction section 304 compares the movement pattern data registered in the selected record with the generated movement pattern data.

On the other hand, if there is no movement pattern data of the detected person (No in ACT 203), the prediction section 304 compares the other data, in other words, the movement pattern data registered in the first device use determination table with the generated movement pattern data (ACT 205).

Thereafter, the prediction section 304 determines whether or not the generated movement pattern data is the movement pattern data of the use of the image processing apparatus 100 as a result of the comparison (ACT 206). If the generated movement pattern data is not the movement pattern data of the use of the image processing apparatus 100 (No in ACT 206), the image processing apparatus 100 ends the processing. The case in which the generated movement pattern data is not the movement pattern data of the use of the image processing apparatus 100 is a case in which the generated movement pattern data is not coincident with the movement pattern data at the time the image processing apparatus 100 is used.

On the other hand, if the generated movement pattern data is the movement pattern data of the use of the image processing apparatus 100 (Yes in ACT 206), the prediction section 304 outputs a message indicating that it is the movement pattern at the time the image processing apparatus 100 is used to the sleep controller 305. If notified that it is a movement pattern at the time the image processing apparatus 100 is used, the sleep controller 305 cancels the sleep state (ACT 207).

According to the image processing apparatus 100 constituted as described above, power consumption can be suppressed. Specifically, the image processing apparatus 100 cancels the sleep state if the movement pattern collected since the person is detected is coincident with the movement pattern at the time the apparatus is used. Therefore, the sleep state is not canceled each time the person is detected. Therefore, the power consumption can be suppressed.

A modification of the image processing apparatus 100 is described below.

In the examples shown in FIG. 4 and FIG. 5, if the person is detected, the movement pattern is collected. However, even if the person is far from the image processing apparatus 100, the movement pattern is collected. Then, detection accuracy of the movement pattern decreases in some cases. As a result, the precision of the determination result of the device usage prediction is also lowered in some cases. Thus, the image processing apparatus may be constituted to collect the movement pattern only if a person is detected at a position close to the image processing apparatus 100. A specific processing is described below.

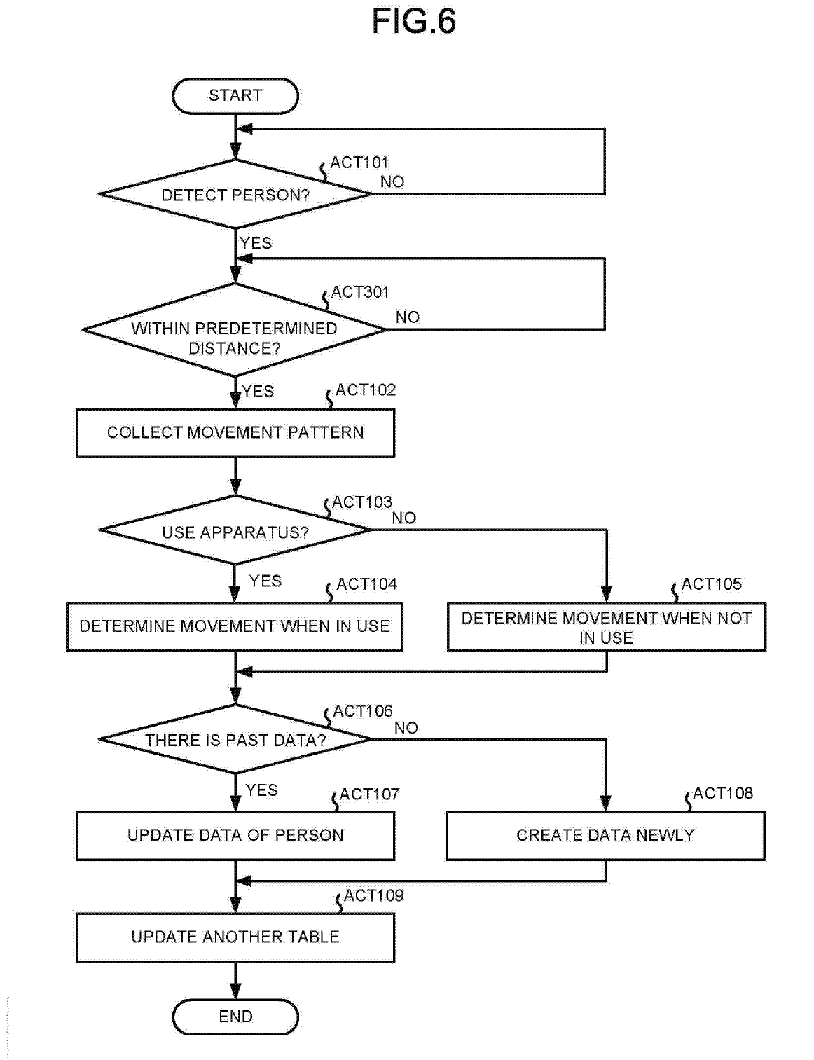

FIG. 6 is a flowchart illustrating the flow of a generation processing of a movement pattern data in a modification in the image processing apparatus 100. The processing in FIG. 6 is executed each time the image capturing device 150 acquires the image. In FIG. 6, the processing same as that in FIG. 4 is donated with the same reference numeral, and the description thereof is omitted.

If the person is detected in the processing in ACT 101 (Yes in ACT 101), the data generation section 303 determines whether or not the person is within a predetermined distance (ACT 301). The data generation section 303 may acquire the distance from the image processing apparatus 100 to the person from a distance measuring sensor and the image, for example. The data generation section 303 determines that the person is within a predetermined distance if the acquired distance is within the predetermined distance. The predetermined distance is a distance determined to be close to the image processing apparatus 100, and may be appropriately set by the user. On the other hand, the data generation section 303 determines that the person is not within the predetermined distance if the acquired distance is not within the predetermined distance.

If the person is not within a predetermined distance (No in ACT 301), the data generation section 303 waits for until the person is present within the predetermined distance. In this case, the data generation section 303 deletes the image data output from the person detection section 302.

On the other hand, if the person is within the predetermined distance (Yes in ACT 301), the data generation section 303 executes the processing subsequent to ACT 102 in the same way as stated above.

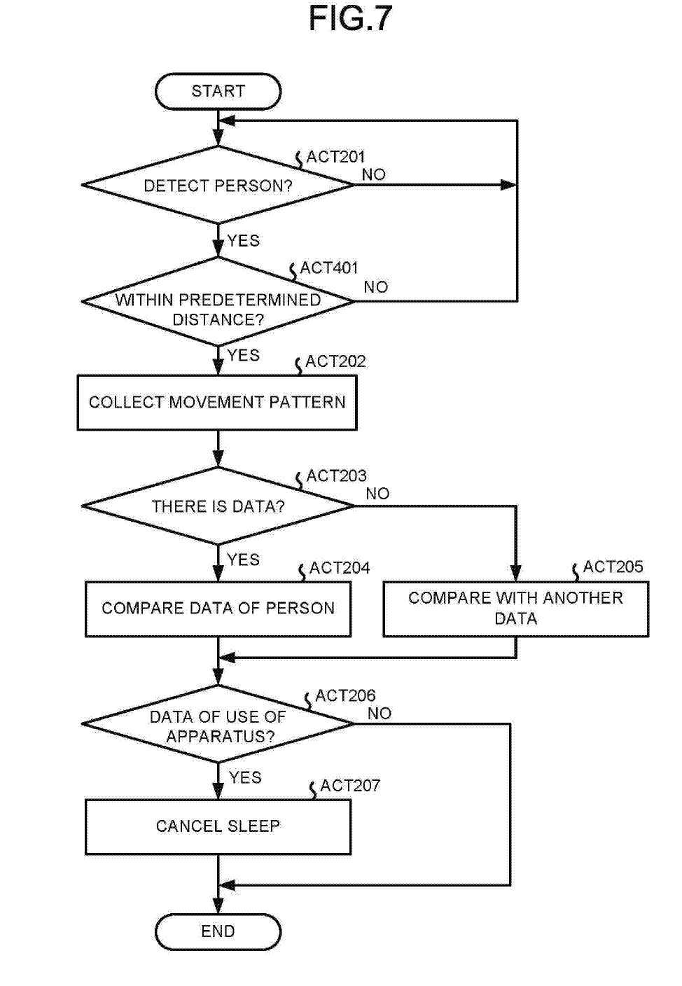

FIG. 7 is a flowchart illustrating the flow of a prediction processing in a modification in the image processing apparatus 100. The processing in FIG. 7 is executed at the time the image processing apparatus 100 is in a sleep state. In FIG. 7, the processing same as that in FIG. 5 is donated with the same reference numeral, and the description thereof is omitted.

If the person is detected in the processing in ACT 201 (Yes in ACT 201), the data generation section 303 determines whether or not the person is within a predetermined distance (ACT 401).

If the person is not within the predetermined distance (No in ACT 401), the data generation section 303 waits for until the person is present within the predetermined distance. In this case, the data generation section 303 deletes the image data output from the person detection section 302.

On the other hand, if the person is within the predetermined distance (Yes in ACT 401), the data generation section 303 executes the processing subsequent to ACT 202 in the same way as stated above.

With the above configuration, the image processing apparatus 100 can improve the detection accuracy of the movement pattern. As a result, it is also possible to improve the accuracy of the determination result of the device usage prediction.

According to at least one embodiment described above, the image processing apparatus 100 has the image capturing device and the sleep controller. The image capturing device captures the periphery of the image processing apparatus. The sleep controller cancels the sleep state if it is predicted to use the image processing apparatus based on the feature data in a plurality of captured images continuously captured by the image capturing device. With such a configuration, the image processing apparatus 100 makes it possible to suppress the power consumption.

The functions of the image processing apparatus 100 according to the foregoing embodiment may be realized by a computer. In this case, programs for realizing the functions are recorded in a computer-readable recording medium and the programs recorded in the recording medium may be read into a computer system to be executed. Further, it is assumed that the “computer system” described herein contains an OS or hardware such as peripheral devices. Further, the “computer-readable recording medium” refers to a portable medium such as a flexible disc, a magneto-optical disk, a ROM, a CD-ROM and the like or a storage device such as a hard disk built in the computer system. Furthermore, the “computer-readable recording medium” refers to a medium for dynamically holding the programs for a short time like a communication wire in a case in which the programs are sent via a communication line such as a network like the Internet or a telephone line or a medium for holding the programs for a certain time like a volatile memory in the computer system serving as a server and a client. The foregoing programs may realize a part of the above-mentioned functions or realize the functions described above by the combination of with the programs already recorded in the computer.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. An image processing apparatus, comprising:
an image capturing device configured to capture a periphery of the image processing apparatus; and
a sleep controller configured to cancel a sleep state if a prediction is generated that the image processing apparatus is used based on a feature data in a plurality of captured images continuously captured by the image capturing device.

2. The image processing apparatus according to claim 1, wherein
the feature data is an orientation of a face of a person captured in a captured image, and
the sleep controller cancels the sleep state if the prediction is generated that the image processing apparatus is used from the orientation of the face of the person captured in the plurality of captured images.

3. The image processing apparatus according to claim 1, wherein
the feature data is an orientation of a body of a person captured in the captured image, and
the sleep controller cancels the sleep state if the prediction is generated that the image processing apparatus is used from the orientation of the body of the person captured in the plurality of captured images.

4. The image processing apparatus according to claim 1, wherein
the feature data is a movement direction of a person captured in the captured image, and
the sleep controller cancels the sleep state if the prediction is generated that the image processing apparatus is used from the movement direction of the person captured in the plurality of captured images.

5. The image processing apparatus according to claim 1, further comprising:
a prediction section configured to predict use or nonuse of the image processing apparatus based on the feature data in the plurality of captured images continuously captured by the image capturing device, wherein
the prediction section predicts that the image processing apparatus is used if the feature data in the plurality of captured images is coincident with a threshold feature data in a case of using the image processing apparatus.

6. The image processing apparatus according to claim 5, wherein
the prediction section predicts use or nonuse using the feature data obtained from the plurality of captured images acquired after a condition that the person captured in the plurality of captured images is present within a range having a predetermined distance from the image processing apparatus is satisfied.

7. The image processing apparatus according to claim 1, further comprising:
a data generation section configured to generate data indicating use or nonuse of the image processing apparatus for a specific person based on the feature data in the plurality of captured images, wherein
the sleep controller cancels the sleep state if the prediction is generated that the image processing apparatus is used based on the data.

8. The image processing apparatus according to claim 7, wherein
the data generation section generates the data from the plurality of captured images acquired after a condition that the person captured in the plurality of captured images is close to the image processing apparatus is satisfied.

9. The image processing apparatus according to claim 1, wherein
the sleep controller cancels the sleep state if the prediction is generated that the image processing apparatus is used based on the feature data in the plurality of captured images through which a person is detected.

10. A sleep cancellation method, comprising:
capturing a periphery of an image processing apparatus; and
canceling a sleep state if a prediction is generated that the image processing apparatus is used based on a feature data in a plurality of captured images continuously captured by the capturing.

11. The sleep cancellation method according to claim 10, further comprising:
canceling the sleep state if the prediction is generated that the image processing apparatus is used from an orientation of a face of a person captured in a captured image in the plurality of captured images.

12. The sleep cancellation method according to claim 10, further comprising:
canceling the sleep state if the prediction is generated that the image processing apparatus is used from an orientation of a body of a person captured in the plurality of captured images.

13. The sleep cancellation method according to claim 10, further comprising:
canceling the sleep state if the prediction is generated that the image processing apparatus is used from a movement direction of a person captured in the plurality of captured images.

14. The sleep cancellation method according to claim 10, further comprising:
predicting use or nonuse of the image processing apparatus based on the feature data in the plurality of captured images continuously captured by the image capturing device, and
predicting that the image processing apparatus is used if the feature data in the plurality of captured images is coincident with a threshold feature data in a case of using the image processing apparatus.

15. The sleep cancellation method according to claim 14, further comprising:
predicting use or nonuse using the feature data obtained from the plurality of captured images acquired after a condition that the person captured in the plurality of captured images is present within a range having a predetermined distance from the image processing apparatus.

16. The sleep cancellation method according to claim 10, further comprising:
generating data indicating use or nonuse of the image processing apparatus for a specific person based on the feature data in the plurality of captured images, and
canceling the sleep state if the prediction is generated that the image processing apparatus is used based on the data.

17. The sleep cancellation method according to claim 16, further comprising:
generating the data from the plurality of captured images acquired after a condition that the person captured in the plurality of captured images is close to the image processing apparatus.

18. The sleep cancellation method according to claim 10, further comprising:
canceling the sleep state if the prediction is generated that the image processing apparatus is used based on the feature data in the plurality of captured images through which a person is detected.

19. A sleep state processing method, comprising:
capturing a periphery of an image processing apparatus;
canceling a sleep state if a prediction is generated that the image processing apparatus is used based on a feature data in a plurality of captured images continuously captured by the capturing; and
storing the feature data to establish a threshold feature data for comparison to a current feature data to facilitate a future prediction.

20. The sleep state processing method according to claim 19, further comprising:
determining a new feature data in the plurality of captured images continuously captured by the capturing; and
comparing the new feature data as the current feature data to the threshold feature data to generate the future prediction.
